(19) United States
(12) Patent Application Publication
(10) Pub. No.: US 2007/0160091 A1
(43) Pub. Date: Jul. 12, 2007

(54) Continuous wave supercontinuum light source and medical diagnostic apparatus using the same

(75) Inventors: Jun Han Lee, Seoul (KR); Young Geun Han, Seoul (KR); Sang Bae Lee, Seoul (KR); Chang Seok Kim, Basan (KR)

Correspondence Address: MCKENNA LONG & ALDRIDGE LLP, 1900 K STREET, NW, WASHINGTON, DC, 20006, US

(73) Assignee: KOREA INSTITUTE OF SCIENCE AND TECHNOLOGY, Seoul (KR)

(21) Appl. No.: 11/583,152

(22) Filed: Oct. 19, 2006

(30) Foreign Application Priority Data
Jan. 11, 2006 (KR) 10-2006-0003011

(51) Int. Cl. H01S 3/30

(52) U.S. Cl. 372/6

(57) ABSTRACT

Disclosed are a continuous wave supercontinuum laser source resonator using low-priced multimode semiconductor lasers as pumping light and applying a rare-earth doped optical fiber and a Highly Nonlinear Dispersion Shifted Fiber (HNL-DSF) to a ring resonator structure to embody a continuous wave supercontinuum light source, and a medical diagnostic apparatus using the same. The resonator consists of a pump combiner for inputting pumping light into the resonator; a rare-earth doped optical fiber for receiving and converting the pumping light into seed light of a predetermined wavelength band; a Highly Nonlinear Dispersion Shifted Fiber (HNL-DSF) for converting the light converted by the rare-earth doped optical fiber and oscillating in the resonator into a continuous wave supercontinuum laser source; and a coupler for outputting the supercontinuum laser source generated from the Highly Nonlinear Dispersion Shifted Fiber (HNL-DSF). Accordingly, it is possible to embody a simple and inexpensive continuous wave supercontinuum laser source.

### CROSS-REFERENCE TO RELATED APPLICATIONS

This application claims all benefits of Korean Patent Application No. 10-2006-0003011 filed on Jan. 11, 2006 in the Korean Intellectual Property Office, the disclosures of which are incorporated herein by reference.

### BACKGROUND OF THE INVENTION

1. Field of the Invention

The present invention relates to continuous wave supercontinuum laser source resonators. More particularly, the present invention relates to continuous wave supercontinuum laser source resonators using low-priced multimode semiconductor lasers as pumping light for use in medical diagnostic systems.

2. Description of the prior art

Currently, in medical fields, various diagnostic apparatuses are used. Among them, it is paid attention to apparatuses using an optical sensor.

An optical coherent tomography (OCT), which is a new technology capable of observing a microstructure up to several mm depth in a non-contact and non-invasive manner, provides a three-dimensional image using an interference phenomenon of a path difference in laser lights.

As requirements for providing such image, it is needed to develop and embody a laser source having a characteristic suitable for a desired purpose. In general, the laser is divided into a pulse mode and a continuous mode depending on time characteristics thereof, divided into a high coherence and a low coherence depending on coherence lengths and divided into ultraviolet, visible and infrared rays depending on wavelengths.

In particular, when light of low coherence is used, it is possible to obtain an accurate image of less resolution, as shown in a following equation 1. Accordingly, it is needed a supercontinuum light spectrum with regard to the application to the OCT.

l_{c}=0.44λ₀/Δλ [equation 1]

where l_{c}: coherence length, λ₀: central wavelength and Δλ: bandwidth.

At this time, although it is required a mean light output power of several mW grade so as to extract a light signal, a continuous mode output has the preference to a pulse mode, so as to prevent a cell tissue from being damaged due to instantaneous power.

In addition, as a wavelength of light becomes longer, an effect of Rayleigh scattering is decreased and thus the light is easy to penetrate into the tissue. However, considering the respective bio-tissues having various constituents such as melanin, water, hemoglobin and the like, it is needed to develop respective lasers for a variety of wavelength bands within infrared areas of 800 nm˜2000 nm.

FIG. 1 shows a structure of a broadband light source using amplified spontaneous emission (ASE) of a general rare-earth optical fiber, and FIG. 2 is a graph showing a variation in spectra of outputted light when increasing an intensity of a pumping light in the structure of FIG. 1.

Referring to FIGS. 1 and 2, the broadband light source using the ASE of the rare-earth optical fiber consists of a rare-earth doped optical fiber (Er/Yb codoped double clad fiber) 10, a pump combiner 30, an isolator 50 and multimode laser diodes 60.

The pumping light of 975 nm outputted from the multimode laser diodes 60 is converted into seed light of a 1560 nm band through the optical fiber 10. The seed light is outputted to an output terminal through the isolator 50. As shown in FIG. 2, this exhibits typical ASE spectra of the optical fiber 10. Accordingly, a bandwidth of the generated light is limited to light emitting bands of the added rare-earth ions, i.e., Er/Yb in FIG. 2.

FIG. 3 shows a structure of a general optical fiber laser source ring resonator and FIG. 4 is a graph showing a variation in spectra of outputted light when increasing an intensity of a pumping light in the structure of FIG. 3.

Referring to FIGS. 3 and 4, the ring resonator consists of a rare-earth doped optical fiber (Er/Yb codoped double clad fiber) 11, a pump combiner 31, a coupler 40, an isolator 51 and multimode laser diodes 61.

The pumping light of 975 nm outputted from the multimode laser diodes 61 is converted into seed light of a 1560 nm band through the optical fiber 11. The seed light generates stimulated emission while oscillating in the ring resonator and the laser source is outputted to a 20% port through the 80:20 coupler 40. As shown in FIG. 4, this exhibits a single peak laser output which is an output shape of the general optical fiber ring laser.

As described above, according to the related art, it is outputted the ASE spectrum of the typical rare-earth doped optical fiber or the single peak laser spectrum which is an output of the general optical fiber ring laser, and a supercontinuum laser source is not outputted.

The related art supercontinuum light source technology can be divided into a superluminescent laser diode and an optical fiber based supercontinuum light source. First, the superluminescent laser diode has advantages of lightweight and continuous mode, but has a limitation in the light output power, so that it is developed for several tens nm bands only. To the contrary, the optical fiber based supercontinuum light source can exhibit supercontiuum spectrum of several hundreds nm, but uses Ti:Siphire laser light of a pulse mode for the light pumping, so that it has limitations in small size and instantaneous high output and the like.

### SUMMARY OF THE INVENTION

Accordingly, the present invention has been made to solve the above problems. An advantage of the invention is that it provides a better optical fiber based continuous wave supercontinuum laser source for application to a medical diagnostic apparatus.

Another advantage of the invention is that it provides an optical fiber based continuous wave supercontinuum laser source which is simpler and of higher performance.

Still another advantage of the invention is that it provides a medical apparatus, light measuring apparatus or optical sensor that is lighter, smaller and less inexpensive.

In order to achieve the above advantages, there is provided a continuous wave supercontinuum laser source resonator comprising: a pump combiner for inputting pumping light into the resonator; a rare-earth doped optical fiber for receiving and converting the pumping light into seed light of a predetermined wavelength band; and a Highly Nonlinear Dispersion Shifted Fiber (HNL-DSF) for converting the light converted by the rare-earth doped optical fiber and oscillating in the resonator into a continuous wave supercontinuum laser source.

The laser source resonator is a ring resonator further comprising a coupler for outputting the supercontinuum laser source generated from the Highly Nonlinear Dispersion Shifted Fiber (HNL-DSF), and an isolator formed between the coupler and the pump combiner and enabling the light oscillation to have a directionality in the resonator.

Alternatively, the laser source resonator is a Fabry-Perot type resonator further comprising a mirror connected to the pump combiner.

The rare-earth doped optical fiber has a double clad fiber structure or single clad fiber structure.

The pumping light incident into the rare-earth doped optical fiber is light pumped from multimode laser diodes or single mode laser diode.

Further, the Highly Nonlinear Dispersion Shifted Fiber (HNL-DSF) is a silica Highly Nonlinear Dispersion Shifted Fiber (HNL-DSF), a photonic crystal optical fiber, or a nonlinear optical fiber made of a material except silica.

The above advantages are achieved by a medical diagnostic apparatus comprising a continuous wave supercontinuum laser source resonator comprising a pump combiner for inputting pumping light into the resonator; a rare-earth doped optical fiber for receiving and converting the pumping light into seed light of a predetermined wavelength band; a Highly Nonlinear Dispersion Shifted Fiber (HNL-DSF) for converting the light converted by the rare-earth doped optical fiber and oscillating in the resonator into a continuous wave supercontinuum laser source; and a coupler for outputting the supercontinuum laser source generated from the Highly Nonlinear Dispersion Shifted Fiber (HNL-DSF).

### BRIEF DESCRIPTION OF THE DRAWINGS

The above advantages of the present invention will be more apparent from the following detailed description taken in conjunction with the accompanying drawings, in which:

FIG. 1 shows a structure of a broadband light source using amplified spontaneous emission (ASE) of a general rare-earth optical fiber;

FIG. 2 is a graph showing a variation in spectra of outputted light when increasing an intensity of a pumping light in the structure of FIG. 1;

FIG. 3 shows a structure of a general optical fiber laser source ring resonator;

FIG. 4 is a graph showing a variation in spectra of outputted light when increasing an intensity of a pumping light in the structure of FIG. 3;

FIG. 5 shows a structure of a continuous wave supercontinuum laser source ring resonator according to an embodiment of the invention;

FIG. 6 is a graph showing a variation in spectra of outputted light when increasing an intensity of a pumping light in the structure of FIG. 5;

FIG. 7 is a graph showing variations in intensities of outputted lights depending on adjustments of pumping light in the structures of FIGS. 1 and 5, and

FIG. 8 shows a structure of a continuous wave supercontinuum laser source Fabry-Perot resonator according to another embodiment of the invention.

### DETAILED DESCRIPTION OF THE ILLUSTRATED EMBODIMENTS

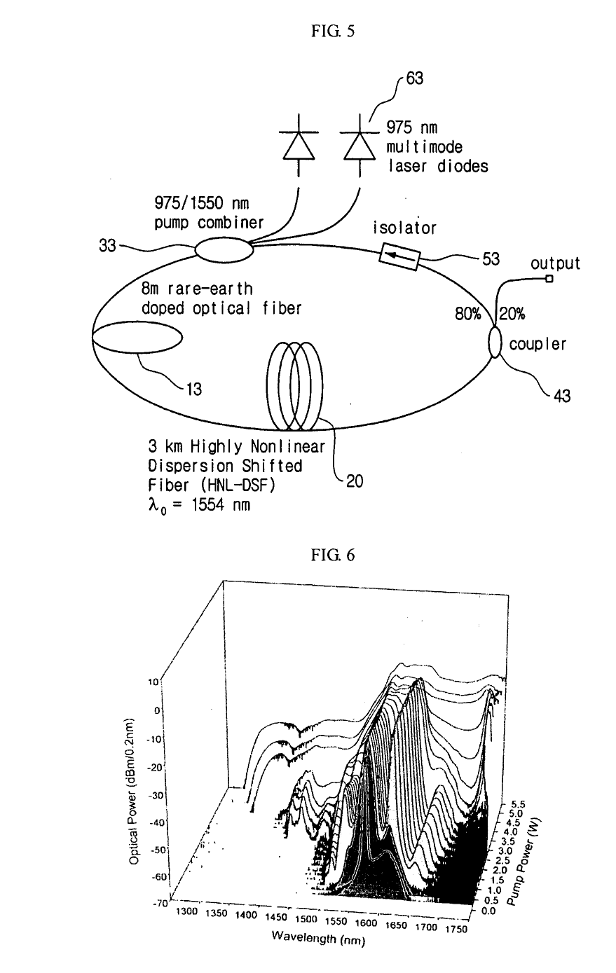

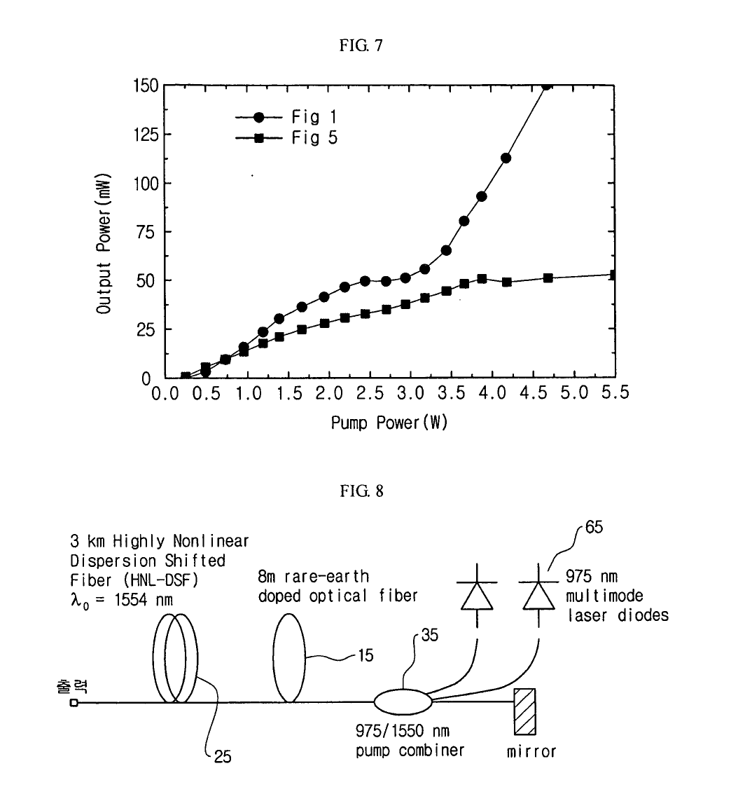

FIG. 5 shows a structure of a continuous wave supercontinuum laser source ring resonator according to an embodiment of the invention.

Referring to FIG. 5, the continuous wave supercontinuum laser source ring resonator comprises a rare-earth doped optical fiber (Er/Yb codoped double clad fiber) 13, a Highly Nonlinear Dispersion Shifted Fiber (HNL-DSF) 20, a pump combiner 33, a coupler 43, an isolator 53 and multimode laser diodes 63.

The rare-earth doped optical fiber 13 has a core erbium absorptivity of 35 dB/m at a wavelength of 1535 nm and a ytterbium aborptivity of a clad layer is ˜5 dB/m at a wavelength of 975 nm. As pumping light of the rare-earth doped optical fiber 13, two multimode semiconductor laser diodes 63 are used, each of which has power of ˜4 W at the wavelength of 975 nm.

Although the rare-earth doped optical fiber 13 has been described to have a double clad fiber structure, it is possible to use one having a single clad fiber structure. In addition, in FIG. 5, as the diode for inputting the pumping light, it has been described an example of the multimode laser diodes 63. However, the invention is not limited thereto and it is possible to use a single mode laser diode for inputting the pumping light.

The Highly Nonlinear Dispersion Shifted Fiber (HNL-DSF) 20 is connected to the rare-earth doped optical fiber 13 and has a nonlinearity constant of about 15.5 W/Km, and a zero dispersion wavelength thereof is about 1554 nm. In addition, a dispersion slope of the Highly Nonlinear Dispersion Shifted Fiber (HNL-DSF) 20 is about 0.027 ps/nm²/Km and a loss thereof is about 1.3 dB/Km. As the Highly Nonlinear Dispersion Shifted Fiber (HNL-DSF) 20, it is possible to use a silica Highly Nonlinear Dispersion Shifted Fiber (HNL-DSF), a photonic crystal optical fiber or a nonlinear optical fiber made of a material except silica.

The pump combiner 33 serves to transfer the pumping light generated from the multimode semiconductor laser diodes 63 to the rare-earth doped optical fiber 13.

The coupler 43 is connected between the Highly Nonlinear Dispersion Shifted Fiber (HNL-DSF) 20 and an output terminal and it is possible to obtain a laser output from the ring resonator by using, for example, a 80%:20% coupler 43.

The isolator 53 is disposed next to the coupler 43 and enables the light oscillation to have a directionality in the ring resonator.

Hereinafter, it will be described an operation of the continuous wave supercontinuum laser source ring resonator having the structure as described above.

As shown in FIG. 5, the pumping light of 975 nm outputted from the multimode laser diodes 63 is converted into seed light of a 1560 nm band through the rare-earth doped optical fiber 13. The seed light generates stimulated emission while oscillating in the ring resonator.

After that, the light oscillating in the ring resonator is converted into supercontinuum light through modulation instability and stimulated Raman scattering in the Highly Nonlinear Dispersion Shifted Fiber (HNL-DSF) 20.

The laser source of supercontinuum outputted from the Highly Nonlinear Dispersion Shifted Fiber (HNL-DSF) 20 is outputted to a 20% port through the 80:20 coupler 43. Hereinafter, it will be described a variation in outputted lights depending on intensities of the pumping light.

FIG. 6 is a graph showing a variation in spectra of outputted light when increasing an intensity of a pumping light in the structure of FIG. 5.

Referring to FIG. 6, as the intensity of the pumping light is increased, the laser output, which has been initially generated at 1568 nm, has another peak at 1608 nm, at a pumping light intensity of 0.49 W. This results from a multimode operation due to a mode hopping which is often seen in an optical fiber laser having a very long resonator length.

After that, by increasing the intensity of pumping light, an interval between the two peaks of wavelength is widened, which can be explained as a Raman pulse generation phenomenon. At a pumping light intensity of 0.73 W, third and fourth peak lights are generated due to a four-wave mixing phenomenon occurring between the central seed light and the second peak light.

Then, strong first-order Raman strokes are generated at 1730 nm and supercontinuum laser source is generated at a pumping light intensity of 4.18 W, so that it is possible to obtain a supercontinuum laser source having a bandwidth of 470 nm or more at a pumping light intensity of maximal 5 W.

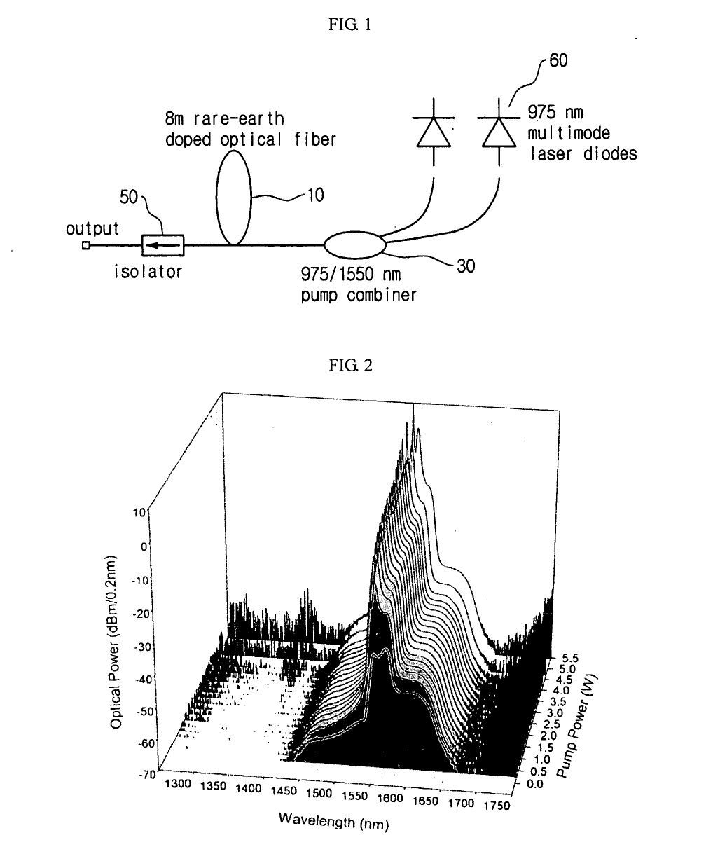

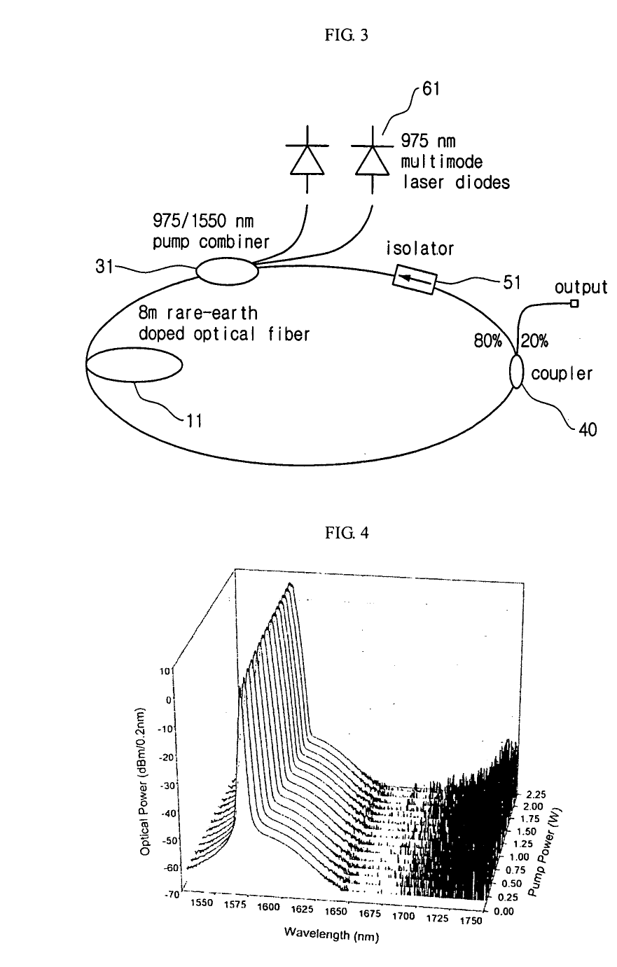

FIG. 7 is a graph showing variations in intensities of outputted lights depending on adjustments of pumping light in the structures of FIGS. 1 and 5.

Referring to FIG. 7, as the intensity of the pumping light is increased, the outputted light is increased. When the pumping light of about 4.18 W is incident, the outputted light is continuously increased in case of FIG. 1. However, in case of the structure of FIG. 5 according to an embodiment of the invention, when the pumping light of 4.18 W is incident, the outputted light is abruptly decreased and a maximal intensity of the outputted light is about 53.4 W even though the pumping light is continuously increased. Accordingly, it is possible to prevent the cell tissue from being damaged due to the instantaneous over-output of the laser source.

FIG. 8 shows a structure of a continuous wave supercontinuum laser source Fabry-Perot resonator according to another embodiment of the invention.

Referring to FIG. 8, it shows a structure of a Fabry-Perot resonator, in place of the isolator and the coupler in the ring resonator shown in FIG. 5.

In FIG. 8, it is shown a structure having a mirror formed behind the pump combiner 35, thereby exhibiting the same effect as the ring resonator. Accordingly, the pumping light outputted from the multimode laser diodes 65 can generate the supercontinuum laser source in the Highly Nonlinear Dispersion Shifted Fiber (HNL-DSF) 25 through the rare-earth doped optical fiber 15.

According to the embodiment having the above structure, by using the inexpensive multimode laser diodes 65 as the pumping light and applying the rare-earth doped optical fiber 15 and the Highly Nonlinear Dispersion Shifted Fiber (HNL-DSF) 25 to the simple ring resonator structure, it is possible to obtain the continuous wave supercontinuum laser source.

As described above, according to the invention, it is possible to embody the continuous wave supercontinuum laser source which is easily manufactured and inexpensive, by using the inexpensive multimode laser diodes as the pumping light and applying the rare-earth doped optical fiber and the Highly Nonlinear Dispersion Shifted Fiber (HNL-DSF) to the simple ring resonator structure.

In addition, since the outputted light is a continuous wave, it is possible to prevent the cell tissue from being damaged due to the instantaneous over-output of the pulse mode supercontinuum light source.

While the invention has been shown and described with reference to certain illustrated embodiments thereof, it will be understood by those skilled in the art that various changes in form and details may be made thereto without departing from the spirit and scope of the invention as defined by the appended claims.

What is claimed is:

1. A continuous wave supercontinuum laser source resonator comprising:
a pump combiner for inputting pumping light into the resonator;
a rare-earth doped optical fiber for receiving and converting the pumping light into seed light of a predetermined wavelength band; and
a Highly Nonlinear Dispersion Shifted Fiber (HNL-DSF) for converting the light converted by the rare-earth doped optical fiber and oscillating in the resonator into a continuous wave supercontinuum laser source.

2. The resonator according to claim 1, wherein the laser source resonator is a ring resonator further comprising:
a coupler for outputting the supercontinuum laser source generated from the Highly Nonlinear Dispersion Shifted Fiber (HNL-DSF); and
an isolator formed between the coupler and the pump combiner and enabling the light oscillation to have a directionality in the resonator.

3. The resonator according to claim 1, wherein the laser source resonator is a Fabry-Perot type resonator further comprising a mirror connected to the pump combiner.

4. The resonator according to claim 1, wherein the rare-earth doped optical fiber has a double clad fiber structure.

5. The resonator according to claim 4, wherein the pumping light incident into the rare-earth doped optical fiber is light pumped from multimode laser diodes.

6. The resonator according to claim 4, wherein the pumping light incident into the rare-earth doped optical fiber is light pumped from a single mode laser diode.

7. The resonator according to claim 1, wherein the rare-earth doped optical fiber has a single clad fiber structure.

8. The resonator according to claim 7, wherein the pumping light incident into the rare-earth doped optical fiber is light pumped from multimode laser diodes.

9. The resonator according to claim 7, wherein the pumping light incident into the rare-earth doped optical fiber is light pumped from a single mode laser diode.

10. The resonator according to claim 1, wherein the Highly Nonlinear Dispersion Shifted Fiber (HNL-DSF) is a silica Highly Nonlinear Dispersion Shifted Fiber (HNL-DSF).

11. The resonator according to claim 1, wherein the Highly Nonlinear Dispersion Shifted Fiber (HNL-DSF) is a photonic crystal optical fiber.

12. The resonator according to claim 1, wherein the Highly Nonlinear Dispersion Shifted Fiber (HNL-DSF) is a nonlinear optical fiber made of a material except silica.

13. A medical diagnostic apparatus comprising a continuous wave supercontinuum laser source resonator, the resonator comprising:
a pump combiner for inputting pumping light into the resonator;
a rare-earth doped optical fiber for receiving and converting the pumping light into seed light of a predetermined wavelength band;
a Highly Nonlinear Dispersion Shifted Fiber (HNL-DSF) for converting the light converted by the rare-earth doped optical fiber and oscillating in the resonator into a continuous wave supercontinuum laser source; and
a coupler for outputting the supercontinuum laser source generated from the Highly Nonlinear Dispersion Shifted Fiber (HNL-DSF).

14. The apparatus according to claim 13, wherein the rare-earth doped optical fiber has a double clad fiber structure.

15. The apparatus according to claim 14, wherein the pumping light incident into the rare-earth doped optical fiber is light pumped from multimode laser diodes.

16. The apparatus according to claim 14, wherein the pumping light incident into the rare-earth doped optical fiber is light pumped from a single mode laser diode.

17. The apparatus according to claim 13, wherein the rare-earth doped optical fiber has a single clad fiber structure.

18. The apparatus according to claim 17, wherein the pumping light incident into the rare-earth doped optical fiber is light pumped from multimode laser diodes.

19. The apparatus according to claim 17, wherein the pumping light incident into the rare-earth doped optical fiber is light pumped from a single mode laser diode.

20. The apparatus according to claim 13, wherein the Highly Nonlinear Dispersion Shifted Fiber (HNL-DSF) is a silica Highly Nonlinear Dispersion Shifted Fiber (HNL-DSF).

21. The apparatus according to claim 13, wherein the Highly Nonlinear Dispersion Shifted Fiber (HNL-DSF) is a photonic crystal optical fiber.

22. The apparatus according to claim 13, wherein the Highly Nonlinear Dispersion Shifted Fiber (HNL-DSF) is a nonlinear optical fiber made of a material except silica.
